(19) United States
(12) Patent Application Publication
(10) Pub. No.: US 2003/0033311 A1
(43) Pub. Date: Feb. 13, 2003

(54) System and method for collaboration of suppliers through shared interactive data resources

(76) Inventor: Andrew J. Skinner, Clifton Park, NY (US)

Correspondence Address: Robert M. Schulman, Esq., Hunton & Williams, Suite 1200, 1900 K Street, N.W., Washington, DC, 20006, US

(21) Appl. No.: 09/927,317

(22) Filed: Aug. 13, 2001

(51) Int. Cl. G06F 7/00

(52) U.S. Cl. 707/100

(57) ABSTRACT

A system and method for facilitating business-to-business transactions using an interactive data resource, such as a Web site. The system and method are oriented toward facilitating customer/supplier and supplier/supplier interactions in the personal care products industry. The system includes an interactive data resource having electronic tools for facilitating data presentation, data navigation, user-to-use transactions, project management, and supplier collaboration. Methods for facilitating new product development and product fulfillment projects using the system are also described.

### BACKGROUND OF THE INVENTION

The invention relates to the field of shared interactive data resources for facilitating business-to-business transactions.

Businesses providing manufactured goods may coordinate with a number of suppliers for the materials and services incorporated within their products. Coordinating among multiple suppliers may be a logistical burden for these businesses. Product development and product fulfillment, for example, may both involve the materials and services of multiple suppliers. Product development may involve market research service suppliers, material suppliers, pre-production manufacturing service providers, product testing service suppliers, market testing service suppliers, manufacturing process design service suppliers, package/label design service suppliers, and other material and service suppliers. Product fulfillment may include material suppliers, manufacturing service suppliers, quality control testing service suppliers, distribution service suppliers, and other material and service suppliers. Coordination among these suppliers may represent considerable transaction and opportunity costs. Specificity of supplier roles, customization of product components, rate of innovation in the product market, turnover among suppliers, high reliance on component quality and compatibility, multi-stage processes performed by different suppliers, and other factors may compound the transaction and opportunity costs.

In the personal care products industry, for example, a number of factors contribute to making coordination burdensome and make collaboration among suppliers a desirable state. Personal care products may include antiperspirants and deodorants, skin and sun care products, color cosmetics, shower and bath soaps, shaving foam and aftershaves, perfumes and colognes, hair care products, feminine hygiene products, oral hygiene products, and other related products. Personal care products are largely chemistry based and development and fulfillment may include related complexities regarding the specialization of chemical suppliers, specialized manufacturing techniques, complex interactions of component materials, required stability and safety testing, proprietary and patent protected material formulas, complex transportation logistics, and other factors. Personal care products are also designed for close human interaction and may need additional safety and toxicity testing and be subject to labeling requirements and other regulations. Personal care products are also both fashion and technology products, subject to rapidly shifting consumer preferences and continual innovation for functional and marketing advantage.

The personal care industry includes a range of customers for the materials and services of suppliers with wide ranging capabilities and interests in the development and fulfillment process. Customers may include large companies devoted to mass marketing personal care products, many of whom maintain at least some in-house product development and fulfillment capabilities. Customers may include smaller, more specialized companies with narrowly defined brands for niche, direct, prestige, and salon marketing. These customers may have fewer product development and fulfillment capabilities. Customers may also include brand only companies, such as clothing designers and other fashion companies that wish to offer branded personal care products as an adjunct to their core business. These companies may have almost no product development and fulfillment capabilities. All of these customers may need to navigate the complexities of product development and fulfillment for personal care products, including coordinating with a number of different suppliers for each product that they offer.

Traditionally, these interactions were accomplished through a combination of individually negotiated communications and relationships, industry organizations, supplier marketing efforts, and other channels. These channels did not provide an accessible, shared resource for information, or the tools to facilitate locating suppliers, negotiating supplier agreements, and managing product development and fulfillment projects.

Computer-based information resources and communications have fueled innovations in business-to-business efficiency. Various tools have been developed for assisting in information sharing and remote communications. The Internet has sparked a recent surge in technologies based upon sharing of digital information. Some industries have started to develop Web sites to act as exchanges for materials among competitors and suppliers. Electronic commerce based upon transactions executed over the Internet have become commonplace for consumer goods and services. The nexus of computer and communications technologies have made video conferencing, Internet telephony, instant messaging, event-based information delivery, and other communication technologies a reality. These technologies have not been applied to solving the specific difficulties associated with product development and fulfillment for the personal care product industry. These technologies have not been applied to facilitating collaboration on product development and fulfillment among suppliers of materials and services.

### BRIEF SUMMARY OF THE INVENTION

One aspect of the invention is an interactive data resource, such as a Web site, for supporting customer/supplier interactions for personal care product development, testing, manufacturing, packaging, and distribution. The interactive data source includes a data presentation engine for providing information related to products, suppliers, materials, and services. The interactive data resource also includes a navigation engine for identifying materials and services meeting customer-defined specifications. The navigation engine provides access to information presented by the data presentation engine. The interactive data resource also includes a transaction engine for initiating purchase transactions with a supplier for materials or services. The transaction engine allows initiation of purchase transactions based upon information provided through the data presentation engine. The data presentation engine may include an industry data source including industry information, such as industry news, technical support, education, training, management, finance, operations, and recruiting. The data presentation engine may include a product formula data source for presenting product formula information. The data presentation engine may include a collaboration competencies data source for presenting supplier competencies for the new product development and fulfillment. The navigation engine may include a supply description index for identifying desired products, materials, or services based upon supply information, such as product types, material types, service types, material ratios, product features, or ingredient features. The navigation engine may include an offer description index for identifying desired products, materials, or services based upon offer information, such as price, lead time, availability, supplier, or transaction terms. The navigation engine may include product, service, material or feature hierarchies for identifying a desired material or service. The transaction engine may include a product selection module, a material selection module, a service selection module, a negotiation support module, a contracting module, an auction module, a transaction execution module, or a fulfillment status module. The interactive data resource may also include a project management engine for coordinating transactions and fulfillment through a plurality of suppliers. The interactive data resource may also include a collaboration engine for providing product development collaboration among a plurality of suppliers.

A second aspect of the invention is a method of using an interactive data resource to complete product development and fulfillment. A customer accesses an interactive data resource providing data exchange with a plurality of suppliers. The customer identifies a product by navigating data presented by the interactive data resource. The customer identifies a manufacturer based upon information provided by the interactive data source in response to the identified product. The customer executes a transaction with the manufacturer through the interactive data resource to contract for the manufacturer's services. The customer identifies a supplier of a material for the product based upon information provided by the interactive data resource in response to the identified product and/or manufacturer. The customer executes a transaction with the supplier of the material through the interactive data resource that includes delivery of the material to the manufacturer. The customer may identify a supplier of testing services for the product based upon information provided by the interactive data resource. The customer may execute a transaction with the supplier of testing services through the interactive data resource. The customer may identify a distributor for the product based upon information provided by the interactive data resource. The customer may execute a transaction with the distributor through the interactive data resource. The customer may monitor the fulfillment of the transactions executed through the interactive data resource.

A third aspect of the invention is a collaboration engine for providing product development collaboration among a plurality of suppliers. The collaboration engine may include a plurality of functional modules with data connections for exchanging data among them. The collaboration engine includes an opportunity identification module that identifies a new product opportunity based upon customer interactions with an interactive data resource. The collaboration engine includes a new product analysis module that identifies materials and services for developing the new product. The collaboration engine includes a collaborator-recruiting module that identifies collaborators based upon the services and materials identified for development of the new product. The collaboration engine includes a relationship formalization module that initiates transactions with each collaborator to formalize collaborator responsibilities for the project. The collaboration engine includes a project management module that provides a shared resource for coordinating phases of development for the new product among collaborators. The opportunity identification module may include a usage-tracking module that identifies new product opportunities based upon aggregate navigation data from customers using the interactive data resource. The opportunity identification module may include a customer suggestion module that receives and aggregates customer suggestions for new products through the interactive data resource. The collaborator-recruiting module may include a collaborator-ranking module that provides a ranked list of possible collaborators for each material or service identified for development of the new product. The collaboration-recruiting module may include a project submission module for communicating a collaboration opportunity to a possible collaborator and receiving a response from the possible collaborator. The collaborator-recruiting module may include a project role presentation module that presents project data limited according to the materials or services of the possible collaborator to prevent circumvention of the collaboration engine. The project management module may include a review module for presenting project data to collaborator decision-makers at project decision points. The project management module may include a conferencing module for providing group communications among a plurality of collaborators. The project management module may include a project data module for aggregating project data for access by collaborators. The collaboration engine may include a targeted marketing module that identifies marketing channels based upon customer interactions with the interactive data resource.

A fourth aspect of the invention is a method of facilitating collaboration among a plurality of suppliers of materials and services for the development of new products. The method includes identifying a new product concept from customer interactions with an interactive data resource. The method includes identifying a new product formulation based upon the new product concept and existing product formulation data. The method includes identifying a plurality of suppliers for materials and services for developing the new product. The identified formulation and a new product development process define supplier roles that are compared against a data source of supplier collaboration capabilities. The method includes initiating a product development project with identified suppliers for materials and services. The step of identifying the new product concept may include analyzing aggregate navigation data from customers using the interactive data resource. The step of identifying the new product concept may include receiving customer product suggestions through the interactive data resource, aggregating received customer product suggestions, and analyzing the aggregated customer product suggestions to identify demand for a new product concept. The step of initiating the product development project may include ranking identified suppliers for each defined supplier role, communicating a collaboration opportunity to identified suppliers according to the ranking, and awaiting confirmation of interest in the collaboration opportunity. The collaboration opportunity may be communicated to another supplier in the rankings for the same supplier role after receiving a denial of interest from the previously contacted supplier. The step of initiating the product development project may include providing project data limited according to the project role identified for a particular supplier. The method may include initiating transactions with each supplier agreeing to collaborate on the project in order to formalize responsibilities for the project. The method may include providing shared project management resources for coordinating the activities of suppliers agreeing to collaborate on the project. The step of providing shared project management resources may include coordinating presentation of project data to collaborator decision-makers at project decision points. The step of providing shared project management resources may include providing group teleconferencing functions among a plurality of collaborators. The step of providing shared project management resources may include aggregating project data and providing secure remote access to the aggregated data according to the project role of a particular supplier. The method may include identifying marketing channels based upon customer interactions with the interactive data resource.

Systems and methods for using the systems embodying the invention provide a combination of shared resources for use in product development and fulfillment. An effect of these systems is that a shared interactive data resource is provided with the tools to improve efficiency of product development and fulfillment, thereby reducing transaction and opportunity costs.

### BRIEF DESCRIPTION OF THE DRAWINGS

FIG. 1 is a schematic diagram of example networked systems for supporting resource sharing through an interactive data resource.

FIG. 2 is an interactive data resource for supporting customer/supplier interactions.

FIG. 3 is flow chart of a method using an interactive data resource for product development and/or fulfillment.

FIG. 4 is a collaboration engine for facilitating product development collaboration among suppliers.

FIG. 5 is flow chart of a method of facilitating collaboration among suppliers.

FIG. 6 is a flow chart of a method of identifying a new product concept for facilitating collaboration among suppliers.

FIG. 7 is a flow chart of a second method of identifying a new product concept for facilitating collaboration among suppliers.

FIG. 8 is a flow chart of a method of identifying suppliers for collaboration.

FIG. 9 is a flow chart of a method of initiating a product development project for collaboration among suppliers.

FIG. 10 is a flow chart of a method of providing shared product management resources for collaboration among suppliers.

### DETAILED DESCRIPTION OF THE INVENTION

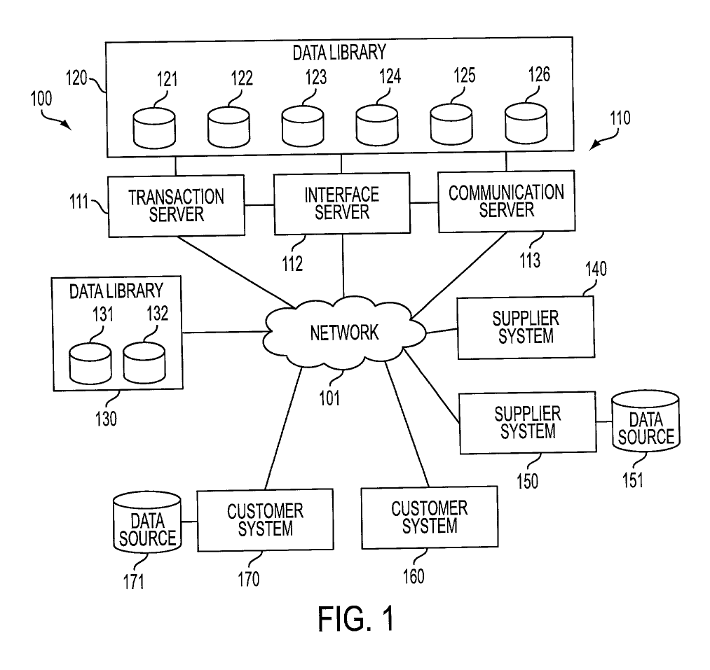

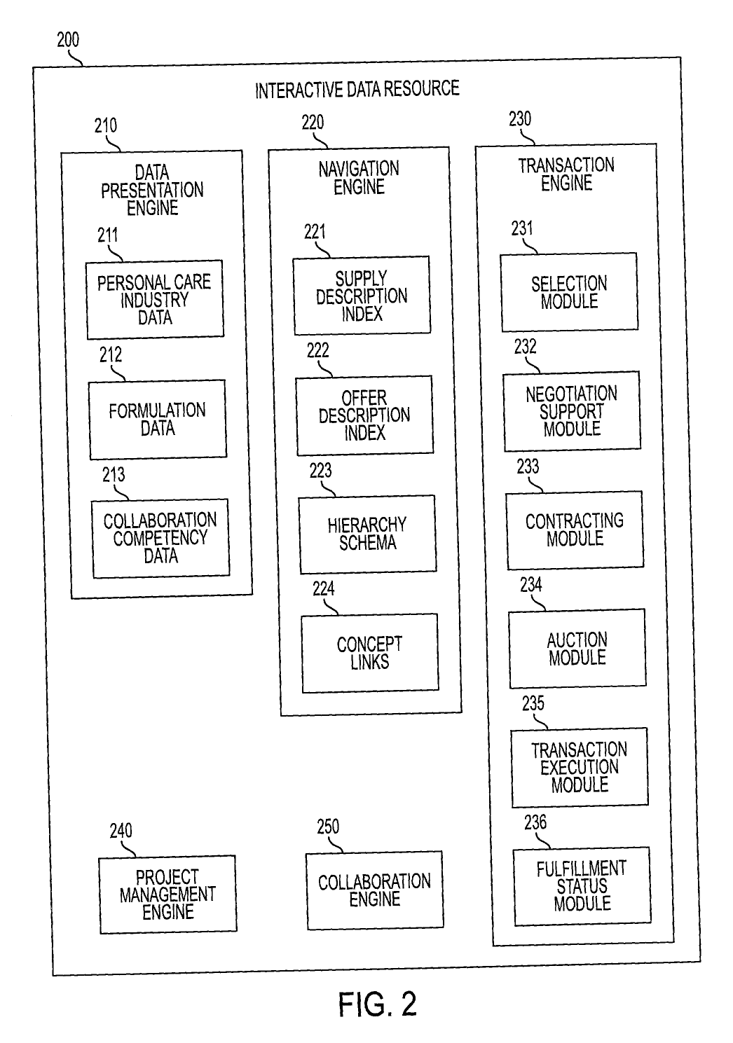

FIG. 1 shows a variety of example networked systems for hosting the functions of the systems and methods described below with regard to FIGS. 2-10. A network 101 interconnects a number of network resources 100. Network 101 may be any large scale wide area network for the communication of electronic data. In a preferred embodiment, network 101 is the Internet. Network resources 100 may include a variety of computerized processing and data systems, such as servers, user terminals, personal computers, data repositories, removable data storage devices, peripheral devices, communication devices, and other devices. Network resources 100 may themselves be networks, such as intranets, extranets, server clusters, home networks, or other public or private networks. In the example shown in FIG. 1, Network resources 100 include a server system 110, a data library 130, a first supplier system 140, a second supplier system 150, a first customer system 160, and a second customer system 170.

Server system 110 may include a plurality of servers and data systems for providing interactive data, transaction, and communication services across network 101. In a preferred embodiment, server system 110 hosts an interactive data resource for use by customers and suppliers for facilitating product development and fulfillment. Server system 110 may be embodied on one or more physical servers. The physical servers of server system 110 may be distributed across multiple geographic locations and electronic addresses. In a preferred embodiment, server system 110 includes redundant clustered servers providing robust interactive access to the functions of the system across multiple connections to network 101. The functions of server system 110 may be provided, at least in part, by third party service providers through remote servers. Server system 110 may include a transaction server 111, an interface server 112, a communication server 113, and a data library 120. Transaction server 111, interface server 112, communication server 113, and data library 120 may be virtual machines within one or more interconnected physical servers and may include overlapping and integrated functions among them. Transaction server 111 may facilitate transactions through server system 110, such as purchase transactions, contract drafting and finalization transactions, user verification and security transactions, and other transactions. Transaction server 111 may facilitate transactions without regard to the interface from which the transaction data is passed. Interface server 112 may provide one or more interfaces for data presentation and navigation. Interface server 112 may provide a plurality of static and dynamic Hypertext Markup Language (HTML) documents for presentation through browsing devices, such as personal computers, Internet appliances, Web-enabled televisions, and other devices. Interface server 112 may provide data presentation and navigation interfaces using a variety of protocols for delivery through a variety of devices, such as telephones, Personal Digital Assistants (PDAs), WAP mobile telephones, two-way pagers and other SMS devices, and other devices. Interface server 112 may utilize the transactional capabilities from transaction server 111, data and data retrieval, possibly including document layouts, content, and navigation, from data library 120, and communication services, protocols, and channels from communication server 113 for delivering interactive data resources to customers and suppliers. Communication server 113 may provide communication services, protocols and channels through network 101 and through other channels, such as a publicly switched telephone network. Communication server 113 may support multiple communication tools for use with an interactive data resource, such as teleconferencing, video conferencing, Internet presentations, information narrowcasting, and correspondence security, tracking and archiving. Data library 120 may provide one or more data sources for transaction server 111, interface server 112, and communications server 113. Data library 120 may represent enterprise data accumulated from multiple aspects of server system 110. In a preferred embodiment, data library 120 is a relational database management server incorporating multiple data storage devices. Data library 120 may include multiple databases, such as databases 121, 122, 123, 124, 125, and 126. Databases 121, 122, 123, 124, 125, and 126 may include conceptually related aggregations of data for supporting any of the functions provided by transaction server 111, interface server 112, and communications server 113. In a preferred embodiment, data library 120 includes databases and data retrieval functions for providing content for an interactive data resource presented through interface server 112.

The example network resources 100 also include one or more data resources external to server system 110, such as data library 130 or data sources 151 and 171 maintained by supplier system 150 and customer system 170 respectively. Data library 130 may represent enterprise data accumulated from sources other than server system 110. For example, data library 130 may represent data aggregated by an academic or industry organization, third party service provider, or another entity providing data relevant to the functions of server system 110. In a preferred embodiment, data library 130 is a relational database management server incorporating multiple data storage devices. Data library 130 may include multiple databases 131 and 132 and database management functions for creating, maintaining, and accessing those databases.

The example network resources 100 also include supplier systems 140 and 150. Supplier systems 140 and 150 may represent a variety of computer systems for accessing the interactive data resource hosted by server system 110. For example, supplier systems 140 and 150 may represent the intranet of a supplier of one or more materials or services. The intranet may include enterprise data and processing systems and a number of user terminals for accessing those enterprise systems. In a preferred embodiment, the intranet may include user terminals, such as personal computers and wireless communication devices, running browser software for accessing the interactive data source of server system 110. As another example, supplier system 140 may represent any electronic device used by a representative of the supplier for accessing the functions of server system 110. As shown for supplier system 150, a supplier system may include its own data resource 151. In one embodiment, supplier system 150 may include a database management system and server system 110 may access data contained in data source 151 for performing one or more functions. For example, data descriptive of the supplier and its materials and services may be maintained in the supplier's own data source and accessed remotely as needed. Similarly, supplier system 150 may maintain project data or other information useful to server system 110. The functions of server system 110 may be integrated with portions of supplier systems 140 and 150.

The example network resources 100 also include customer systems 160 and 170. Customer systems 160 and 170 may represent a variety of computer systems for accessing the interactive data resource hosted by server system 110. For example, supplier systems 160 and 170 may represent the intranet of a customer for manufacturing related materials and services. The intranet may include enterprise data and processing systems and a number of user terminals for accessing those enterprise systems. In a preferred embodiment, the intranet may include user terminals, such as personal computers and wireless communication devices, running browser software for accessing the interactive data source of server system 110. As another example, customer system 160 may represent any electronic device used by a representative of the customer for accessing the functions of server system 110. As shown for customer system 170, a customer system may include its own data resource 171. In one embodiment, customer system 170 may include a database management system and server system 110 may access data contained in data source 171 for performing one or more functions. For example, data descriptive of the customer's product fulfillment and development requests, existing supplier contracts, and project data may be maintained in the customer's own data source and accessed remotely as needed. The functions of server system 110 may be integrated with portions of customer systems 160 and 170.

The network resources 100 shown in FIG. 1 are only a few examples of the hardware systems and distribution of software systems that could be used to implement the systems and methods described below with regard to FIGS. 2-10. A wide variety of servers, operating systems, database management systems, data mining and data distribution systems, terminal devices, communication protocols, interface and programming languages, software applications, and other components are available to implement the described systems and methods. Implementation of the described systems and methods using various existing or to-be-developed components will be readily apparent to those of ordinary skill in the art.

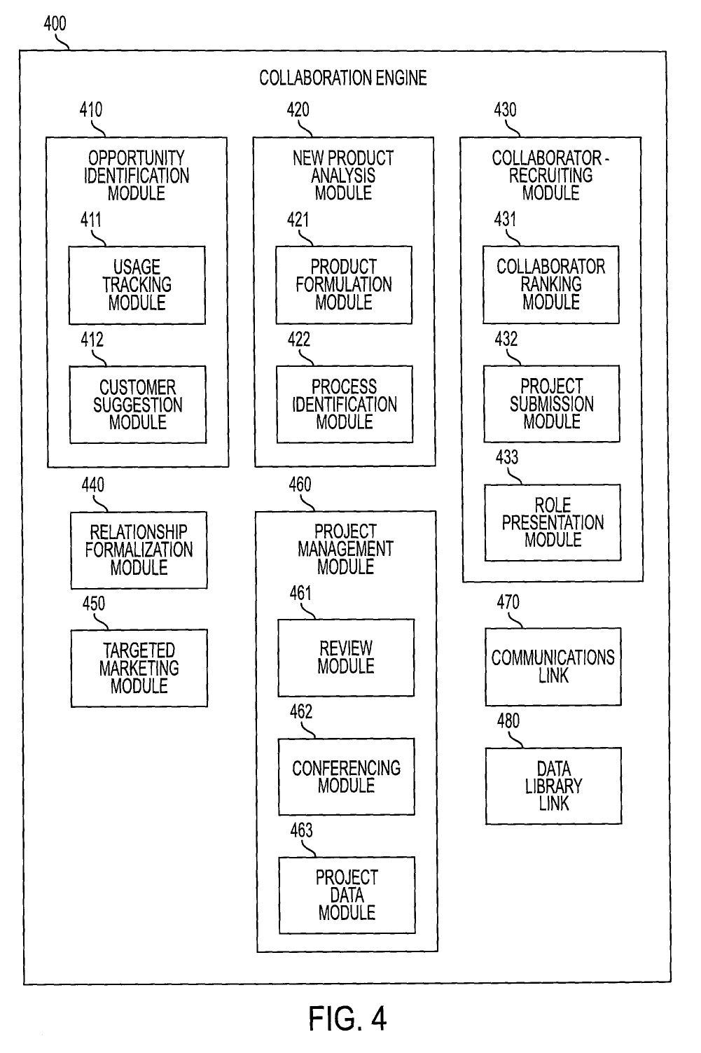

FIGS. 2 and 4 show and describe a number of functional engines and modules for accomplishing one or more tasks or providing one or more tools. The functional engines and modules may each contain a combination of software and/or hardware for performing a task or a set of tasks. For example, a data processor, a memory, and an instruction set (i.e., computer programming code) may be all that are needed for such functional engine or module to carry out the tasks necessary for a given embodiment of each functional engine or module. More commonly, however, multiple input and output devices, a plurality of short term and long term memory systems, a plurality of layers of computer code (i.e., operating system, application software, etc.), a plurality of communication devices, and multiple processors may be used for each such functional engine or module. Additionally, multiple ones of such functional engines or modules may share the same hardware and portions of a software library. In some cases, a functional engine or module may contain one or more other functional modules. As will be understood by those of ordinary skill in the art, the functional engines and modules described herein may be embodied in a large number of equivalent combinations of code objects and hardware. The combinations represented by the functional engines and modules described herein are conceptual and should not be construed as a limiting structure for the multiple hardware and software combinations capable of executing the functional modules' tasks.

FIG. 2 shows an Interactive Data Resource 200 for supporting customer/supplier interactions. An interactive data resource may include any electronic system for the selective exchange of data between the resource and multiple simultaneous users. In a preferred embodiment, Interactive Data Resource 200 is a Web site accessible over the World Wide Web. Interactive Data Resource 200 may include multiple access types with or without differentiated interfaces, such as through WAP, SMS, interactive television, or voice interfaces. In a preferred embodiment, Interactive Data Resource 200 includes information and functions directed toward customers and suppliers in the personal care products industry. Specifically, Interactive Data Resource 200 may provide a collaborative marketplace for the exchange of materials and services related to personal care products. Interactive Data Resource 200 may include a combination of information, transaction, and communication resources for facilitating customer/supplier interactions in the personal care industry for multi-party product development or fulfillment.

Interactive Data Resource 200 includes a number of engines for performing a set of related functions. The functions may be embodied in one or more modules. Interactive Data Resource 200 includes a Data Presentation Engine 210, a Navigation Engine 220, a Transaction Engine 230, a Project Management Engine 240, and a Collaboration Engine 250. Data Presentation Engine 210 formats and displays data drawn from one or more data sources to the users. Navigation Engine 220 provides one or more ways to intuitively access the data of Data Presentation Engine 210. Transaction Engine 230 provides functionality for performing one or more transactions between users. Project Management Engine 240 provides tools for centralizing access to project data and communication among users regarding a particular product related project. Collaboration Engine 250 provides tools for identifying and organizing collaborative product development opportunities for multiple supplier users. The various engines may be functionally interconnected for carrying out their respective functions within interactive data resource 200. The various engines may share resources, processing threads, caches, state information, communication channels, and session and persistent data among them for enabling their functions. Interoperation of the engines may appear seamless from the user perspective.

Data Presentation Engine 210 presents information to the users for facilitating the functions of Interactive Data Resource 200. In a preferred embodiment, data presentation engine 210 includes information descriptive of various aspects of the personal care product industry and its products, materials, services, and suppliers. Data Presentation Engine 210 may include a plurality of static and dynamically generated documents for display to users upon request. In one embodiment, Data Presentation Engine includes a Personal Care Industry Data module 211, a Formulation Data module 212, and a Collaboration Competency Data module 213.

Personal Care Industry Data module 211 may include a variety of information resources for educating, assisting, and providing reference materials to user of Interactive Data Resource 200. For example, Personal Care Industry Data module 211 may include industry news, technical support, educational materials, training materials, management information, financial information, operations information, or recruiting information. Personal Care Industry Data module 211 may include articles, lists, interactive guides, frequently asked questions, directories of outside resources, industry publications, and other resources. Personal Care Industry Data module 211 may include news groups, chat rooms, online presentations and seminars, and other interactive community building tools. In one embodiment, Personal Care Industry Data module 211 may include information targeted at consumers for education and enhancing consumer relations with the industry.

Formulation Data module 212 may include detailed technical and marketing information regarding materials and products. Formulation Data module 212 may include descriptions of material and product features, such as health and aesthetic benefits (e.g., shine, color, vitamin content, “all natural,” etc.). Formulation Data module 212 may include safety, compatibility/solubility, and physical properties information for products and materials. Formulation Data module 212 may include formulation information for products and materials describing the component materials for products and materials, with or without quantification. In one embodiment, access to predetermined levels of detail in formulation information may be restricted based upon user identity.

Collaboration Competency Data module 213 may include descriptions of various suppliers and the materials and services they offer. Collaboration Competency Data module 213 may include detailed descriptions of each suppliers line of available materials and services, including standard materials available, chemical production capabilities and capacities, research and testing facilities and expertise, and mixing, storage, and transportation capabilities. Collaboration Competency Data module 213 may include general descriptions of the suppliers, such as location, contact information, supplier marketing materials, or background information such as history, personnel biographies, supplier resume, facility descriptions, or key customer/project descriptions. Collaboration Competency Data module 213 may include information highlighting each suppliers abilities, interests, and preconditions for engaging in collaborative product development activities.

Navigation Engine 220 provides one or more ways to navigate the information presented by Data Presentation Engine 210. In a preferred embodiment, Navigation Engine 220 provides multiple tools for navigating the information presented by Data Presentation Engine 210. Navigation Engine 220 may include one or more search engines for locating specific information. Navigation Engine 220 may include one or more indexes of information for presentation through Data Presentation Engine 210. The indexes may include multiple descriptive fields by which information can be searched for, evaluated, and accessed. The search engines may be provided through a combined search engine that may or may not allow the user to specify fields or indexes in which to search. Navigation Engine 220 may include one or more schema for linked navigation of the information presented be Data Presentation Engine 210. In a preferred embodiment, the Navigation Engine 220 includes at least one hierarchy for navigating the information. Navigation Engine 220 may include a plurality of conceptual links between related information in different levels of a hierarchy or outside of the hierarchies themselves. In one embodiment, Navigation Engine 220 includes a Supply Description Index module 221, an Offer Description Index module 222, a Hierarchy Schema module 223, and a Concept Links module 224.

Supply Description Index module 221 may include an index of materials, services, and products offered by various suppliers for search, retrieval, and comparison according to material, service, and product details. Supply Description Index module 221 may include a plurality of indexes for locating suppliers, products, materials, and services according to a variety of criteria. Supply Description Index module 221 may include a number of descriptive fields by which information can be located. For example, one or more indexes may include searchable fields for locating suppliers, products, materials, and services by product type, material type, service type, manufacturing process, safety standards, compatibility/solubility, physical properties, material ratios, product features, material features, or formulation information. Supply Description Index module 221 may allow users to identify products, materials, and services available from multiple suppliers.

Offer Description Index module 221 may include an index of materials, services, and products offered by various suppliers for search, retrieval, and comparison according to offer details for the material, service, or product from a specific supplier. Offer Description Index module 221 may allow a user to search for a product, material, or service according to offer features, such as price, lead time, availability, quantity discounts, supplier information, quality tolerances, or transaction terms. Supplier information may include details, such as supplier ratings and reviews for quality, reliability, timeliness, financial security, and other facts that may influence a purchase/contract decision. Description Index module 221 may integrate with Supply Description Index module 221 such that a customer may simultaneously search for products, materials, and services according to both supply and offer descriptions. Offer Description Index module 222 may allow a user to display and/or compare information for a number of suppliers offering similar or related products, materials, or services. Offer Description Index module 222 may include an index of supplier collaboration competencies.

Hierarchy Schema module 223 may provide one or more organizational hierarchies for accessing information of all kinds presented through Data Presentation Engine 210. Hierarchy Schema module 223 may include hierarchical organization schema for suppliers, products, materials, and services. Hierarchy Schema module 223 may include hierarchical organization schema for personal care industry information, formulation information, or collaboration competency information. Hierarchy Schema module 223 may include access points for various functional tools, such as search engines, transactional functions, interactive community resources, and other functions of Interactive Data Resource 200. In a preferred embodiment, Hierarchy Schema module 223 defines a Web Site organization. For example, Hierarchy Schema module 223 may define a product hierarchy according to a classification scheme, such as high level categories (e.g., hair care, antiperspirant/deodorant, skin care, etc.) with various levels of increasingly specific sub-categories (e.g., shampoos, conditioners, hair color, spray deodorant, stick deodorant, lotions, sunscreens, etc.). The product hierarchy may allow for parallel organizational schemes, such as separate classifications for men's, women's, children's, and baby products. Hierarchy Schema module 223 may provide intuitive navigation of product categories to locate increasingly specific product information. Navigation according to Hierarchy Schema module 223 may provide access to more narrowly focused tools, such as search engines running on narrower indexes or with predefined search fields.

Concept Links module 224 provides access to information and functions of Interactive Data Resource 200 according to individually defined relationships rather than an overall hierarchy. Concept Links module 224 may define a number of conceptual links between information and functions throughout a defined hierarchy, regardless of position within the hierarchy. Concept Links module 224 may define conceptual links to information and functions existing outside a defined hierarchy, such as miscellaneous functions or functions and information maintained by third parties.

Transaction Engine 230 provides various transactional functions of Interactive Data Resource 200 for facilitating customer/supplier interaction. In a preferred embodiment, Transaction Engine 230 enables electronic contracting and transaction execution for purchase transactions between customers and suppliers. Transaction Engine 230 may include a variety of functions for enabling electronic commerce. In one embodiment, Transaction Engine 230 includes a Selection Module 231, a Negotiation Support Module 232, a Contracting Module 233, an Auction Module 234, a Transaction Execution Module 235, and a Fulfillment Status Module 236. Selection Module 231 may allow a user to identify one or more products, services, or materials desired for purchase from a particular supplier. Identification may include defining transaction information, such as quantity, desired delivery date, and delivery location. Negotiation Support Module 232 may provide a secure channel of communication between customers and suppliers for negotiating the details of more complex transactions, such as those for custom materials or services. Negotiation Support Module 232 may include communication archiving, negotiation process automation, negotiation status monitoring, real time communications, negotiation counseling or mediation, and other functions for supporting the negotiation process. Contracting Module 233 may provide tools for drafting, finalizing, and formalizing a contract for materials or services. Contracting Module 233 may include model contracts for various transaction types, pre-approved contract clauses, deal frameworks, draft and revision sharing and monitoring, and user authentication and digital signatures for contract finalization. Auction Module 234 may allow users to define terms for auctions and reverse auction of products, materials, services, or project needs. Transaction Execution Module 235 may provide for the execution and settlement of transactions in which funds are transferred. Transaction Execution Module 235 may provide a variety of payment types, payment verification, payment tracking, and electronic settlement for transactions between customers and suppliers. Fulfillment Status Module 236 may provide tools for tracking the fulfillment status of one or more materials or services within a particular project, contract, or order. Fulfillment Status Module 236 may include production schedules, production updates, communication channels and archives, and fulfillment inquiries and updates.

Project Management Engine 240 provides various functions for organizing interactions between multiple parties to a single project, such as a customer and one or more suppliers. Project Management Engine 240 may provide a location for centralizing information regarding a particular project, such as project specifications, contact information for various parties, project status updates, project related contracts, project timelines, and other information. Project Management Engine 240 may include tools for presenting project data to and acquiring authorization from project decision-makers at project decision points. Project Management Engine 240 may provide a variety of communication channels for facilitating presentations, conferences, and correspondence among the parties to the project.

Collaboration Engine 250 provides various tools for facilitating cooperation among suppliers for the fulfillment of customer needs. In a preferred embodiment, Collaboration Engine 250 includes tools for identifying unmet customer needs, identifying suppliers to collaborate on a new product development project, and overseeing the progress of the development project. An example collaboration engine is further described below with regard to FIG. 4.

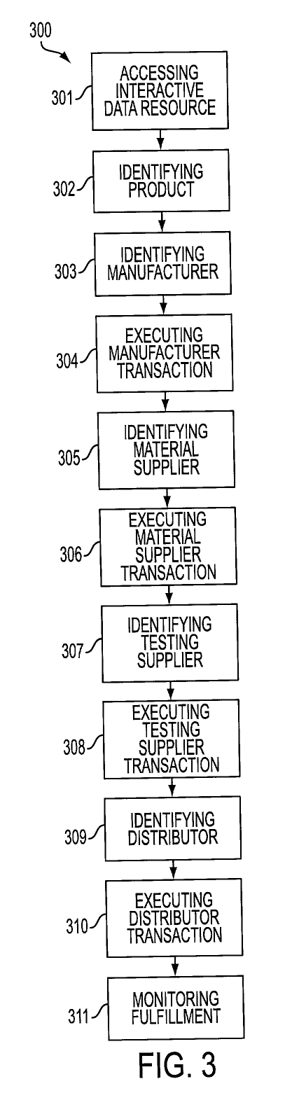

FIG. 3 shows a method 300 for using an interactive data resource, such as interactive data resource 200 described above, for product development or fulfillment. In step 301, a user accesses an interactive data resource for facilitating product development and fulfillment. In a preferred embodiment, the user accesses a Web site over the Internet by directing a browser in a terminal device to the universal resource locator (URL) of the Web site. Accessing the Web site may also include providing user identification and security information. In step 302, the user identifies a product of interest. The user may identify the product of interest by using search engines, menu selections, navigation hierarchies, or combinations thereof to identify the desired product. The user may review product description information, use comparison tools, or access other information resources to assist in making a decision regarding available products. In step 303, the user may identify a manufacturer for the product. The user may use a combination of navigation techniques and information resources to identify the manufacturer of choice. In step 304, the user may execute a transaction with the identified manufacturer electronically through the interactive data resource. Executing a manufacturer transaction may negotiation, contracting, and/or exchange of funds through the interactive data resource. The interactive data resource may enable one or more forms of data, voice, or video communications for facilitating the manufacturer transaction. In step 305, the user may identify a material supplier through the interactive data resource. Identification of a materials supplier may include an evaluation of the product and manufacturer to identify material components for the product. Identification of material suppliers based upon the identified materials may be accomplished through a combination of navigation techniques and information resources. In step 306, the user executes a transaction for materials with the identified material supplier through the interactive data resource. The transaction for materials may be executed using tools similar to those provided for the manufacturer transaction. Steps 305 and 306 may be repeated for multiple materials for the product. In step 307, the user may identify a supplier of testing services or other services through the interactive data resource. Identification of needed/recommended testing services or other services may be based upon an evaluation of the product, manufacturer, materials, or material suppliers involved in the project. Identification of testing service suppliers based upon identification of needed/recommended testing services may be accomplished though a combination of navigation techniques and information resources. In step 308, the user executes a transaction for testing services or other services with the identified testing services supplier through the interactive data resource. The transaction for testing services may be executed using tools similar to those provided for the manufacturer transaction. Steps 307 and 308 may be repeated for multiple services for the product. In step 309, the user may identify a supplier of distribution services through the interactive data resource. Identification of distribution services may be based upon an evaluation of the product or manufacturer doing final production. Identification of distribution service suppliers may be accomplished though a combination of navigation techniques and information resources. In step 310, the user executes a transaction for distribution services or other services with the identified distribution services supplier through the interactive data resource. The transaction for distribution services may be executed using tools similar to those provided for the manufacturer transaction. Steps 309 and 310 may be repeated for multiple distribution service suppliers for the product, such as for distribution in different regions. In step 311, the user may use the interactive data resource to monitor fulfillment of the various materials and services transacted for. Monitoring fulfillment may include accessing information resources and communication tools for remotely tracking the activities of the various suppliers. The steps described in method 300 may not be involved in all product development or fulfillment projects conducted through the interactive data resource. For example, a customer with its own manufacturing facilities may not choose to identify or execute a transaction for manufacturing services (steps 303 and 304). Similarly, a user may identify and/or execute a transaction with a supplier of materials or services through traditional means for one or more components of a product development or fulfillment project. Such a user may still benefit from the use of method 300 for other portions of the project. The combinations of navigation techniques, information resources, and communication tools may by substantially as shown and described with reference to FIG. 2 above.

FIG. 4 shows a Collaboration Engine 400 for use in an interactive data resource, such as interactive data resource 200 in FIG. 2. Collaboration Engine 400 may also provide a tool for use in conjunction with other information systems. Collaboration Engine 400 may provide a variety of tools for facilitating collaboration between multiple suppliers on a single new product development project. The new product development project may not be initiated directly by a customer or a collaborator on the project. In a preferred embodiment, the project may be initiated by third party service provider based upon customer use of an interactive data resource. Collaboration Engine 400 may provide multiple tools for governing relationships between collaborators. Collaboration Engine 400 may oversee timing, completion, quality control, compatibility and coordination of component materials and services, and communications among collaborators to insure the successful and efficient completion of the project. In one embodiment, Collaboration Engine 400 includes an Opportunity Identification Module 410, a New Product Analysis Module 420, a Collaborator Recruiting Module 430, a Relationship Formalization Module 440, a Targeted Marketing Module 450, and Project Management Module 460. In one embodiment, such as when Collaboration Engine 400 is not integrated into an interactive data resource, Collaboration Engine 400 may also include a Communications Link 470 for data transfer to user systems and a Data Library Link 480 for accessing one or more remote data libraries.

Opportunity Identification Module 410 provides tools for identifying new product opportunities for the initiation of collaborative projects. In a preferred embodiment, new product opportunities are identified automatically by Opportunity Identification Module 410 based upon scheduled or event-based evaluation of relevant data (e.g., site usage data, customer suggestion data, etc.). In an alternate embodiment, a user may initiate new projects based upon evaluation of relevant data using the tools provided by Opportunity Identification Module 410. In a preferred embodiment, Opportunity Identification Module 410 includes a Usage Tracking Module 411 and a Customer Suggestion Module 412.

Usage Tracking Module 411 aggregates data based upon user navigation of an interactive data resource. In one embodiment, Usage Tracking Module 411 may aggregate information from user searches, document navigation, and inputs for various form documents and tool interfaces. This information may be collected along standard Web site usage logs and metrics. The aggregated data may be compared against a data source for existing product descriptions to identify gaps in existing product coverage. For example, Usage Tracking Module may notice that users frequently navigate through a hierarchy for personal care products and stop when the arrive at men's aloe hand lotion, for which no products are shown. In one embodiment, Usage Tracking Module 411 may be keyed to unsuccessful product searches through a product search engine. For example, Usage Tracking Module 411 may recognize multiple searches run for lip balm with vitamin D supplements, for which no results are returned from the product database. Usage Tracking Module 411 may track usage data through time and recognize trends in user requests for recognizing shifts in customer. For example, Usage Tracking Module 411 may notice a trend towards new products containing antibacterial components. Usage Tracking Module 411 may compare a list of product types against a list of products currently offered containing antibacterial components in order to identify product types for which no antibacterial product exists. In this way, Usage Tracking Module 411 may identify a new product opportunity for antibacterial deodorant. Usage Tracking Module 411 may identify and report relevant usage trends for purposes other than the identification of new product opportunities, such as identifying demand trends for existing products. In one embodiment, Usage Tracking Module 411 may track usage data for a consumer oriented interactive data resource in order to identify new product opportunities.

Customer Suggestion Module 412 aggregates user suggestions from one or more interactive data resources for identification of new product opportunities. Customer Suggestion Module 412 may be linked to one or more forms through which users of an interactive data resource submit ideas for new products. Customer Suggestion Module 412 aggregates and organizes the suggestions in order to compare the suggestions to existing product data sources and identify new product opportunities. Customer Suggestion Module 412 may include a product description hierarchy for harmonizing terminology used in customer suggestions. Customer Suggestion Module 412 may include comparison logic for categorizing product suggestions according to abstractions of their content extending beyond literal equivalence in suggestions submitted. For example, Customer Suggestion Module 412 may include an algorithm for identifying individual components in a customer suggestions, so that they may be compared without regard to placement of qualifying terms (e.g., vitamin D shampoo with aloe and aloe shampoo with vitamin D would be recognized as equivalents). In one embodiment, Customer Suggestion Module 412 may accept and analyze suggestions from consumers through a consumer oriented interactive data resource.

New Product Analysis Module 420 analyzes identified new product concepts in order to identify the materials and services recommended for development of the new product. New Product Analysis Module 420 may identify a variety of supplier roles to be fulfilled in order to develop the new product. New Product Analysis Module 420 may base its analysis on existing products and existing product process models. In a preferred embodiment, New Product Analysis Module 420 includes a Product Formulation Module 421 and a Process Identification Module 422. Product Formulation Module 421 may utilize a data source of existing product formulations and material and process properties (e.g., compatibility/solubility, material physical properties, material benefits, etc.) in order to identify a prospective component list. Process Identification Module 422 may identify a new product development template based upon the identified components and standard product development requirements. Component materials and processes may be used to define supplier roles that should be filled to develop the new product.

Collaborator Recruiting Module 430 provides tools for selecting and communicating with multiple collaborators for the fulfillment of the supplier roles and initiation of the new product development project. Collaborator Recruiting Module 430 may receive a new product concept, a list of supplier roles, and a list of capability preferences associated with each supplier role. Collaborator Recruiting Module 430 may use the supplier roles and capabilities to identify possible collaborator suppliers for the project. In a preferred embodiment, Collaborator Recruiting Module 430 includes Collaborator Ranking Module 431, Project Submission Module 432, and Role Presentation Module 433. Collaborator Ranking Module 431 identifies one or more suppliers for each supplier role in the project. In a preferred embodiment, Collaborator Ranking Module 431 compares the supplier roles and associated capability preferences to a data source of collaborator competencies for identifying possible one or more suppliers. Suppliers may be ranked according to the quality of their competency match with the capability preferences. Other factors may also be considered for ranking the suppliers for each role, such as the ability of a single supplier to fulfill multiple roles, past performance in development projects, preferred supplier status, and other factors. Project Submission Module 432 communicates the collaboration opportunity to the preferred suppliers for each supplier role. Project Submission Module 432 may maintain a queue of possible supplier collaborators for each supplier role. Project Submission Module 432 may await a response from suppliers to which a collaboration opportunity has been communicated. In the event that the opportunity is declined, Project Submission Module 432 may communicate the collaboration opportunity to the next supplier in the queue. Role Presentation Module 433 presents information specific to the potential collaborator's supplier role. In one embodiment, the information presented to the potential collaborator may be limited in such a way as to prevent the potential collaborator from being able to construct the product concept and pursue development of the project outside the collaboration. For example, the opportunity may be communicated to a supplier decision-maker electronically, along with an identification and password for accessing an interactive data resource with project data. The amount and nature of the project data displayed may be defined by the supplier role and associated with the identification and password.

Relationship Formalization Module 440 provides tools for formalizing supplier responsibilities for the project. In one embodiment, project details may be generated and communicated by Collaboration Engine 400 through Project Submission Module 432 and supplier acquiescence to the details may be a part of accepting the supplier role defined. Alternatively, Collaboration Engine 400 may provide a deal framework and tools for formalizing project details, such as some supplier responsibilities and rewards. Relationship Formalization Module 440 may utilize tools described above with regard to Negotiation Support Module 232, Contracting Module 233, and Transaction Execution Module 235 in FIG. 2. Relationship formalization with one or more suppliers may signify the beginning of the product development project.

Targeted Marketing Module 450 may provide information with regard to the eventual marketing of the newly developed product. In one embodiment, Targeted Marketing Module 450 may utilize information aggregated by Opportunity Identification Module 410 to project market statistics and identify preferred marketing channels. Targeted Marketing Module 450 may pursue direct solicitation of customers based upon customer associated data within the tracking data or customer suggestions. In one embodiment, Targeted Marketing Module 450 may provide marketing data and projections based upon that marketing data to potential collaborators in order to induce collaboration.

Project Management Module 460 provides various tools for organizing interactions between multiple parties to a single project. Project Management Module 460 may oversee adherence to a project timeline. Project Management Module 460 may provide project information to supplier representatives and decision-makers. In a preferred embodiment, Project Management Module 460 includes a Review Module 461, a Conferencing Module 462, and a Project Data Module 463. Review Module 461 includes tools for presenting project data to and acquiring authorization from project decision-makers at project decision points. For example, at various points throughout the collaboration progress and testing reports may be aggregated and presented for assessment of the continuing viability of the project. Conferencing Module 462 provides one or more communication channels for facilitating presentations, conferences, and correspondence among the parties to the project. For example, Conferencing Module 462 may provide a video conferencing tool for meetings among decision makers at the supplier collaborators, regardless of their physical locations. Project Data Module 463 provides access to information regarding a particular project. Project data may be centralized in a single data source or may be provided via location information for multiple remote data source containing project information. Project information may include project specifications, contact information for various parties, project status updates, project related contracts, project timelines, and other information. Project Data Module 463 may include tools for summarizing and analyzing project data for supplier representatives and decision-makers. Project Data Module 463 may provide scheduled or event based updates on the status of the project through a variety of communication channels, such as electronic mail, short message service, voice message, or other terminal device for receiving automated information delivery.

Communications Link 470 provides one or more communication channels for each supplier. Communications Link 470 may include data communications through an interactive data resource, or other data, voice, or video communications. Communications Link 470 may be inherent in interoperability with an interactive data source or other information system.

Data Library Link 480 provides one or more data access channels for one or more data libraries. The operation of Collaboration Engine 400 may utilize multiple data sources, such as a data source for storing project data, a data source of aggregate usage tracking or customer suggestion data, data sources for product, supplier, material and service descriptions, data sources for formulation, process, and supplier role information, and other data sources. Data Library Link 480 may be inherent in interoperability with an interactive data source or other information system.

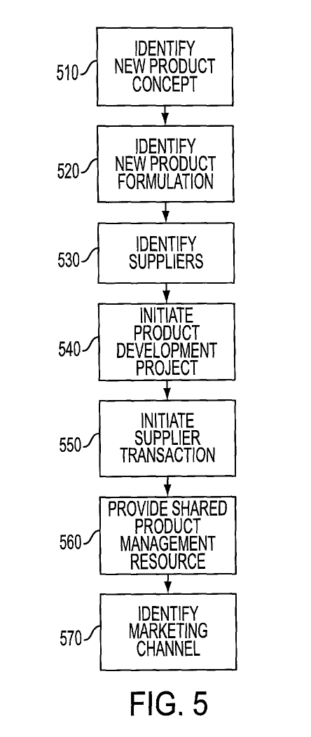

FIGS. 5-10 show a method 500 of facilitating collaboration among suppliers for the development of new products. Method 500 may be performed through an information system in electronic communication with suppliers and customers. In a preferred embodiment, method 500 is performed by a collaboration engine, such as collaboration engine 400 in FIG. 4. The steps of method 500 may be performed using systems substantially as described above with regard to FIGS. 1-4. In one embodiment, the steps of method 500 may be performed by an information system with substantially minimal human intervention. In an alternate embodiment, some amount of human review and input into the information system may initiate or contribute to one or more steps. In step 510, the information system identifies a new product concept. In step 520, the information system identifies a formulation for the new product concept. In step 530, the information system identifies suppliers for one or more component materials and services for development of a new product based upon the new product concept. In step 540, the information system initiates a product development project for development of the new product concept. In step 550, the information system executes transactions with one or more suppliers to formalize supplier responsibilities for the project. In step 560, the information system provides a shared product management resource for facilitating collaboration among suppliers for the duration of the project. In step 570, the information system identifies marketing channels for the new product.

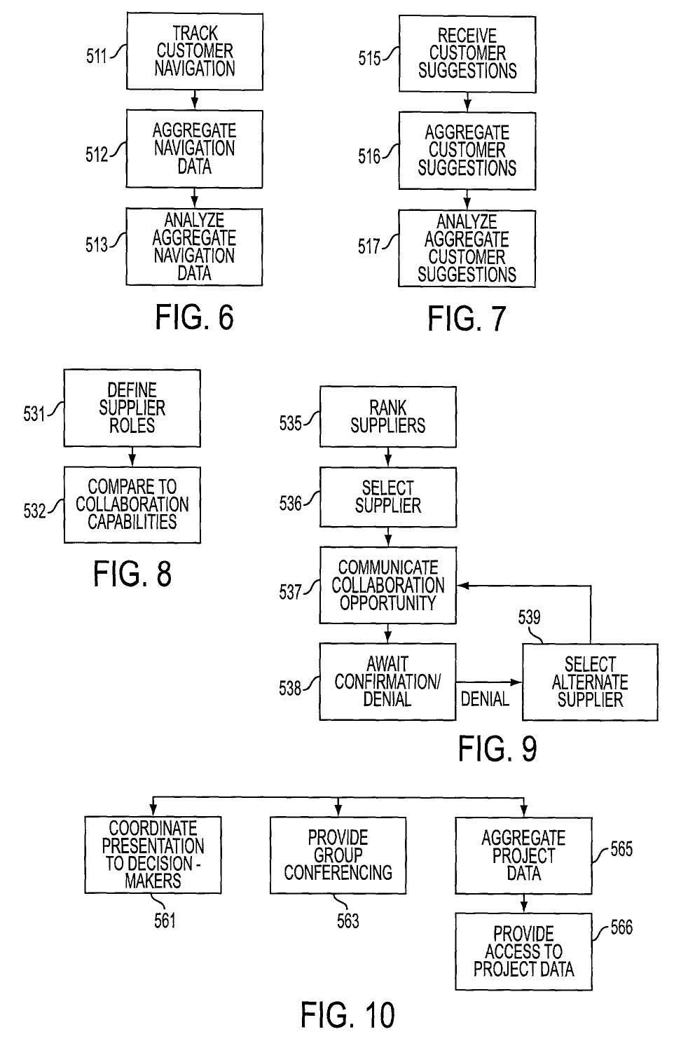

Identification of the new product concept in step 510 may include analyzing one or more data sources to evaluate unmet customer, consumer, or market needs. FIGS. 6 and 7 show example methods of identifying new product concepts. In FIG. 6, step 511, the information system tracks customer navigation of an interactive data resource. In step 512, the customer navigation engine is aggregated in a data source. In step 513, the information system analyzes the aggregated customer navigation data to recognize trends and instances evidencing unmet needs among customers. In FIG. 7, step 515, the information system may receive customer suggestions through an interactive data resource. In step 516, the information system may aggregate customer suggestions in a data source. In step 517, the information system may analyze the aggregated customer suggestions in order to identify new product concepts.

Identification of a new product formulation in step 520 may include analyzing one or more data sources based upon a new product concept identified in step 510. In a preferred embodiment, the information system may compare features of the new product concept to related products in a product formulation data source in order to identify one or more potential or approximate product formulations. Identification of the new product formulation may include identification of one or more processes for developing or manufacturing the new product.

Identification of suppliers in step 530 may include matching suppliers with supplier roles associated with the new product development project. FIG. 8 shows an example method of identifying suppliers. In step 531, the information system may define supplier roles for the product development project. The supplier roles may be defined based upon the identified product formulation and an appropriate product development process. In step 532, the information system may compare the defined supplier roles against the collaboration competencies of one or more suppliers. Comparison of collaboration competencies may allow the information system to identify what suppliers are most likely to be capable of fulfilling each supplier role.

Initiating a product development project in step 540 may include selecting suppliers for collaborating on the project. In FIG. 9, an example method of selecting suppliers for collaboration is shown. In step 541, the information system may rank suppliers for each supplier role according to a preferential scheme for involving them in a given project. In step 542, the information system may select a supplier for each supplier role based upon the rankings. In step 543, the information system communicate a collaboration opportunity to the selected suppliers. In step 544, the information system will await a response from the selected suppliers. The information system may include a time out duration at which it will treat a lack of response as a denial. If the supplier denies interest in the collaboration opportunity, the information system will select an alternate supplier for the supplier role, such as the next supplier according to the rankings, in step 545. The information system may then return to step 543 and communicate the collaboration opportunity to the alternate supplier. If the supplier confirms interest, the information system will initiate a supplier transaction (see step 550).

Initiating a supplier transaction in step 550 may include formalizing project responsibilities with each of the supplier collaborating on the project. Formalization may be automated by presenting project terms, including benefits and responsibilities, in the collaboration opportunity communication. Formalization may be automatic upon confirmation of acceptance of the project by the supplier. Alternatively, the information system may provide tools for facilitating formalization of supplier responsibilities through negotiation among the suppliers.

Providing shared project management resources in step 560 may include providing a variety of tools for overseeing and facilitating communications and information sharing among the collaborating suppliers. FIG. 10 shows a method of providing a variety of tools for project management. In step 561, the information system coordinates presentations of project related data to supplier decision-makers at project decision points. In step 562, the information system provides group conferencing from remote locations in order to facilitate a team approach to project development among suppliers. In step 563, the information system aggregates project data and, in step 564, provides secure access to the project data.

Identifying marketing channels in step 570 may include analyzing data resources used to identify the product development opportunity for identifying potential customers. Identification of marketing channels may include identifying individual customers to whom the new product may be marketed. Identification of marketing channels may include abstraction of customers to identify a market sector of interest, rather than individual customers.

The steps described in FIGS. 5-10 regarding method 500 may not be involved in all product development projects conducted in accordance with the method. The steps in described with regard to FIGS. 6-10 are only examples of the steps described with regard to FIG. 5 and may not be involved in all embodiments of method 500. Not all of the steps described with regard to FIG. 5 may be enabled by all collaborative information systems or may not be useful for any particular product development project.

This invention has been described in connection with the preferred embodiments. These embodiments are intended to be illustrative only. It will be readily appreciated by those skilled in the art that modifications may be made to these preferred embodiments without departing from the scope of the invention as defined herein.

What is claimed is:

1. An interactive data resource for supporting customer/supplier interactions for personal care product development, testing, manufacturing, packaging, and distribution, comprising:
a data presentation engine including information related to suppliers, products, materials, and services and accessible by a plurality of customers and a plurality of suppliers;
a navigation engine functionally integrated with the data presentation engine; and,
a transaction engine functionally integrated with the data presentation engine and supporting transactions between customers and suppliers.

2. The interactive data resource of claim 1, wherein the data presentation engine includes a personal care industry data source.

3. The interactive data resource of claim 1, wherein the data presentation engine includes a product formulation data source.

4. The interactive data resource of claim 1, wherein the data presentation engine includes a supplier collaboration competencies data source.

5. The interactive data resource of claim 1, wherein the navigation engine includes a supply description index.

6. The interactive data resource of claim 1, wherein the navigation engine includes an offer description index.

7. The interactive data resource of claim 1, wherein the navigation engine includes navigation hierarchies for products, suppliers, materials, or services.

8. The interactive data resource of claim 1, wherein the transaction engine includes a selection module, a negotiation support module, a contracting module, an auction module, a transaction execution module, or a fulfillment status module.

9. The interactive data resource of claim 1, further comprising a project management engine functionally integrated with the data presentation engine.

10. The interactive data resource of claim 1, further comprising a collaboration engine functionally integrated with the data presentation engine.

11. An interactive data resource for supporting customer/supplier interactions for personal care product development, testing, manufacturing, packaging, and distribution, comprising:
means for presenting information related to suppliers, products, materials, and services that is accessible by a plurality of customers and a plurality of suppliers;
means for navigating presented information in order to identify products, materials, and services meeting customer-defined specifications; and,
means for initiating a purchase transaction for identified products, materials, and services based upon presented information.

12. A method of using an interactive data resource to complete product development and fulfillment, comprising the steps of:
accessing an interactive data resource providing data exchange with a plurality of suppliers;
identifying a product based upon navigating data presented by the interactive data source;
identifying at least one manufacturer for the product based upon navigating data presented by the interactive data resource;
executing a transaction with the identified manufacturer for manufacture of the product through the interactive data resource;
identifying at least one supplier of a material for the product based upon information presented by the interactive data resource; and
executing a transaction with the identified supplier for delivery of the material for the product to the identified manufacturer through the interactive data source.

13. The method of claim 12, further comprising the steps of:
identifying at least one supplier of testing services for the product based upon information presented by the interactive data source; and
executing a transaction with the identified supplier of testing services for the product through the interactive data resource.

14. The method of claim 12, further comprising the steps of:
identifying at least one distributor for the product based upon information presented by the interactive data source; and
executing a transaction with the identified distributor for the product through the interactive data resource.

15. The method of claim 12, further comprising the step of monitoring the fulfillment of at least one transaction through the interactive data source.

16. The method of claim 12, wherein the interactive data source includes supplier, product, material, and service information for the personal care product industry.

17. A collaboration engine for providing product development collaboration among a plurality of suppliers, comprising:
an opportunity identification module;
a new product analysis module;
a collaborator-recruiting module;
a relationship formalization module;
a project management module; and
at least one communication link connecting to the plurality of suppliers.

18. The collaboration engine of claim 17, wherein the opportunity identification module includes a usage tracking module associated with an interactive data resource.

19. The collaboration engine of claim 17, wherein the opportunity identification module includes a customer suggestion module associated with an interactive data resource.

20. The collaboration engine of claim 17, wherein the new product analysis module includes a product formulation module.

21. The collaboration engine of claim 17, wherein the new product analysis module includes a process identification module.

22. The collaboration engine of claim 17, wherein the collaborator-recruiting module includes a collaborator ranking module.

23. The collaboration engine of claim 17, wherein the collaborator-recruiting module includes a project submission module.

24. The collaboration engine of claim 17, wherein the collaborator-recruiting module includes a role presentation module.

25. The collaboration engine of claim 17, wherein the project management module includes a review module.

26. The collaboration engine of claim 17, wherein the project management module includes a conferencing module.

27. The collaboration engine of claim 17, wherein the project management module includes a project data module.

28. The collaboration engine of claim 17, further comprising a targeted marketing module.

29. A collaboration engine for providing product development collaboration among a plurality of suppliers, comprising:
means for identifying a new product opportunity based upon customer interactions with an interactive data resource;
means for identifying materials and services for development of the new product;
means for identifying collaborators for a project to develop the new product based upon the materials and services identified;
means for initiating at least one transaction with each identified collaborator to formalize collaborator responsibilities for the project;
means for coordinating phases of development for the project among the collaborators; and
means for communicating with the collaborators.

30. A method of facilitating collaboration among a plurality of suppliers of materials and services for development of new products, comprising the steps of:
identifying a new product concept from customer interactions with an interactive data source;
identifying a new product formulation based upon the new product concept and existing product formulation data;
identifying a plurality of suppliers of materials and services based on the new product formulation and a new product development process; and
initiating a product development project with identified suppliers of materials and services to develop the new product concept.

31. The method of claim 30, wherein the step of identifying the new product concept includes analyzing aggregate navigation data from customers using the interactive data source.

32. The method of claim 30, wherein the step of identifying the new product concept includes the steps of:
receiving customer product suggestions through the interactive data source;
aggregating customer product suggestions; and
analyzing the aggregate customer product suggestions to identify demand for the new product concept.

33. The method of claim 30, wherein the step of identifying the plurality of suppliers of materials and services includes the steps of:
defining supplier roles base on the new product formulation and the new product development process; and
comparing the defined supplier roles against a data source of supplier collaboration capabilities.

34. The method of claim 30, wherein the step of initiating the product development project includes the steps of:
ranking identified suppliers for a plurality of supplier roles;
communicating a collaboration opportunity related to a defined supplier role to a chosen supplier based upon the supplier rankings for the defined supplier role; and
awaiting communication of interest in the collaboration opportunity from chosen supplier.

35. The method of claim 30, wherein the step of initiating the product development project includes the step of providing limited project data to a supplier based upon a supplier role.

36. The method of claim 30, further comprising the step of initiating transactions with a plurality of suppliers agreeing to collaborate on the product development project.

37. The method of claim 30, further comprising the step of providing shared project management resources accessible by a plurality of suppliers agreeing to collaborate on the product development project.

38. The method of claim 30, wherein the step of providing shared project management resources includes coordinating presentation of project data to collaborator decision-makers at project decision points.

39. The method of claim 30, wherein the step of providing shared project management resources includes providing group conferencing functions among a plurality of suppliers agreeing to collaborate on the product development project.

40. The method of claim 30, wherein the step of providing shared project management resources includes the steps of:
aggregating project data; and
providing secure remote access to the aggregated project data according to supplier identification and a defined supplier role.

41. The method of claim 30, further comprising the step of identifying marketing channels based upon customer interactions with the interactive data resource.
